(19) United States
(12) Patent Application Publication
(10) Pub. No.: US 2021/0073686 A1
(43) Pub. Date: Mar. 11, 2021

(54) SELF-STRUCTURED MACHINE LEARNING CLASSIFIERS

(71) Applicants: Yuan Yuan Ding, Shanghai (CN); GUO QIANG HU, Shanghai (CN); Jun Zhu, Shanghai (CN); Jing Chang Huang, Shanghai (CN); Sheng Nan Zhu, Shanghai (CN); Fan LI, Shanghai (CN); Peng Ji, Nanjing (CN)

(72) Inventors: Yuan Yuan Ding, Shanghai (CN); GUO QIANG HU, Shanghai (CN); Jun Zhu, Shanghai (CN); Jing Chang Huang, Shanghai (CN); Sheng Nan Zhu, Shanghai (CN); Fan LI, Shanghai (CN); Peng Ji, Nanjing (CN)

(21) Appl. No.: 16/563,036

(22) Filed: Sep. 6, 2019

(51) Int. Cl. G06N 20/20

(52) U.S. Cl. CPC G06N 20/20

(57) ABSTRACT

Techniques for generating machine learning architectures are provided. A data set is received for training one or more machine learning (ML) models, where the data set comprises labeled exemplars for a plurality of classes. The data set is partitioned into a training set and a testing set. A first ML model is trained using the training set, and a quality of the first ML model with respect to each class of the plurality of classes is evaluated using the testing set. Upon determining that the quality of the first ML model is below a predefined threshold with respect to a first class and a second class of the plurality of classes, a subset of the training set is identified, where each exemplar in the subset corresponds to either the first class or the second class. A second ML model is trained using the subset of the training set.

### BACKGROUND

The present disclosure relates to machine learning, and more specifically, to self-structuring hierarchical classifiers to improve functionality.

Some machine learning models can be used to classify input into various categories. The accuracy or performance of the model often varies with respect to each category or class. Retraining or refining the model(s) in any way (e.g., by providing more training data) can affect the accuracy of any class, however. Thus, efforts to improve performance for some classes typically have secondary effects on other classes. For example, by attempting to improve accuracy for a first class (e.g., by utilizing additional training data for the first class), the model may lose accuracy with respect to other classes that were already adequate. Similar problems arise in adding new classes to the model. Further, using current techniques, the retraining process typically requires significant time and computational expense.

### SUMMARY

According to one embodiment of the present disclosure, a method is provided. The method includes receiving a data set for training one or more machine learning (ML) models, wherein the data set comprises labeled exemplars for a plurality of classes, and partitioning the data set into a training set and a first testing set. The method further includes training a first ML model using the training set and evaluating, using the first testing set, a quality of the first ML model with respect to each class of the plurality of classes. Upon determining that quality of the first ML model is below a predefined threshold with respect to a first class and a second class of the plurality of classes, the method includes identifying a subset of the training set, wherein each exemplar in the subset corresponds to either the first class or the second class and training a second ML model using the subset of the training set.

According to a second embodiment of the present disclosure, a computer-readable storage medium is provided. The computer-readable storage medium contains computer program code that, when executed by operation of one or more computer processors, performs an operation. The operation includes receiving a data set for training one or more machine learning (ML) models, wherein the data set comprises labeled exemplars for a plurality of classes, and partitioning the data set into a training set and a first testing set. The operation further includes training a first ML model using the training set and evaluating, using the first testing set, a quality of the first ML model with respect to each class of the plurality of classes. Upon determining that quality of the first ML model is below a predefined threshold with respect to a first class and a second class of the plurality of classes, the operation includes identifying a subset of the training set, wherein each exemplar in the subset corresponds to either the first class or the second class and training a second ML model using the subset of the training set.

According to a third embodiment of the present disclosure, a system is provided. The system includes one or more computer processors, and a memory containing a program which, when executed by the one or more computer processors, performs an operation. The operation includes receiving a data set for training one or more machine learning (ML) models, wherein the data set comprises labeled exemplars for a plurality of classes, and partitioning the data set into a training set and a first testing set. The operation further includes training a first ML model using the training set and evaluating, using the first testing set, a quality of the first ML model with respect to each class of the plurality of classes. Upon determining that quality of the first ML model is below a predefined threshold with respect to a first class and a second class of the plurality of classes, the operation includes identifying a subset of the training set, wherein each exemplar in the subset corresponds to either the first class or the second class and training a second ML model using the subset of the training set.

### BRIEF DESCRIPTION OF THE SEVERAL VIEWS OF THE DRAWINGS

FIGS. 1A and 1B depict self-structured hierarchical machine learning classifiers, according to one embodiment disclosed herein.

FIG. 2 is a block diagram illustrating a machine learning system configured to structure and train hierarchical machine learning models, according to one embodiment disclosed herein.

FIG. 3 is a flow diagram illustrating a method of training hierarchical machine learning models, according to one embodiment disclosed herein.

FIG. 4 is a flow diagram illustrating a method of training hierarchical machine learning models, according to one embodiment disclosed herein.

FIG. 5 is a flow diagram illustrating a method of processing data using hierarchical machine learning models, according to one embodiment disclosed herein.

FIG. 6 is a flow diagram illustrating a method of using hierarchical machine learning models, according to one embodiment disclosed herein.

### DETAILED DESCRIPTION

Embodiments of the present disclosure provide self-structuring machine learning (ML) models that can refine and improve accuracy for desired classes without affecting accuracy or performance of other classes. In some embodiments, the self-structuring models can further add, adjust, and/or remove classes without affecting the model performance with respect to the other classes. In some embodiments, an initial ML model is trained to classify input, and the accuracy of each class or category is evaluated. For classes that underperform (e.g., with accuracy below a threshold), in one embodiment, one or more secondary classifiers are trained. In an embodiment, if the initial model classifies input into one of the identifier underperforming categories, the input is forwarded to the secondary classifier for additional evaluation. In some embodiments, classes can be grouped based on the needed or desired accuracy, with individual classifiers trained for each group as needed.

In an embodiment, the system provides self-structuring ML models that can automatically identify underperformance, prepare additional or alternative models, structure the models hierarchically as appropriate, and ensure adequate results across the relevant classes. As used herein, underperformance of a model with respect to a given class means that the accurate, precision, consistency, and/or reliability of the model is below defined criteria for the class, and/or where the quality of the model is otherwise below predefined criteria for the class. In some embodiments, the ML models are neural networks. In one embodiment, deep convolutional neural networks (DCNNs) are trained and linked to form hierarchical models that analyze input data to classify it into defined categories.

For example, the models may be configured to receive digital images and identify/classify the contents of the image. In one such embodiment, the models can determine, for example, whether the image includes a bird, a flower, a vehicle, and the like. Further, in some embodiments, the models determine the type of bird, flower, vehicle, and the like. In embodiments, the classifications provided by the models can be as granular as desired by the user. Additionally, in some embodiments, the user(s) can define minimum required or desired accuracy and/or precision for the models. In some embodiments, the required performance can be defined on a per-class basis. For example, the model may be considered adequate if it can categorize flowers with 85% accuracy, while it must simultaneously identify vehicles with 95% accuracy. Embodiments of the present disclosure provide techniques to configure such models.

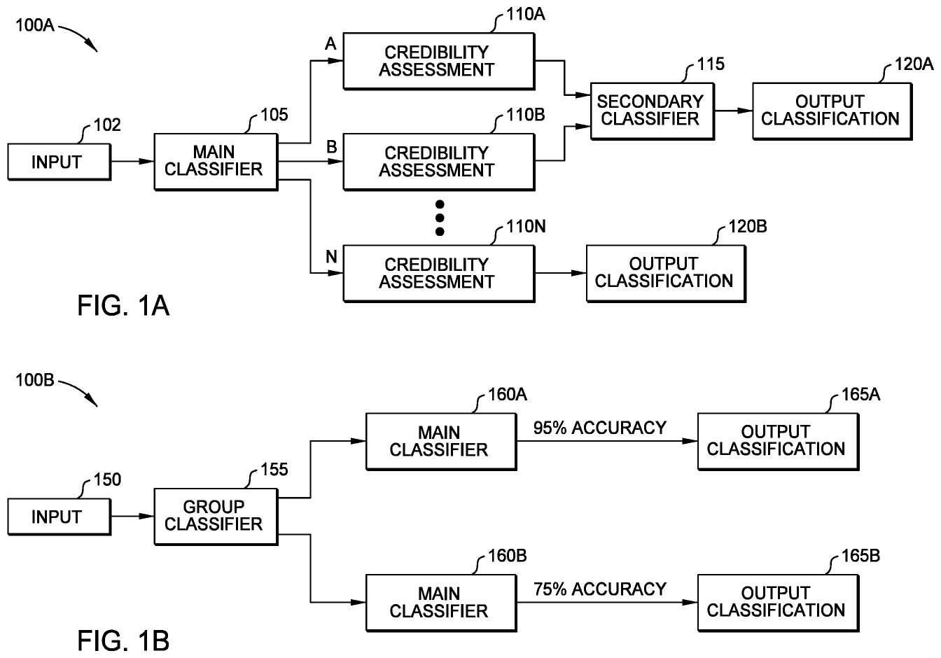

FIG. 1A depicts a self-structured hierarchical machine learning classifier, according to one embodiment disclosed herein. In the illustrated workflow 100A, Input 102 is received and provided to a Main Classifier 105. In embodiments, the Input 102 can correspond to any data. For example, the Input 102 may include one or more images, audio and/or video data, stream data, files, documents, records, and the like. Similarly, in embodiments, the Input 102 can be received from any source. In an embodiment, the Input 102 is received and provided to the ML model(s) in order to classify or categorize the input.

In the illustrated embodiment, the Input 102 is initially provided to a Main Classifier 105. In an embodiment, the Main Classifier 105 is trained on a corpus of training data, where the training data includes a number of labeled exemplars. In one embodiment, each exemplar includes sample input and a corresponding classification/categorization. The Main Classifier 105 can then be trained by providing the class as target output for the corresponding input. In embodiments, the Main Classifier 105 classifies the Input 102 into one of several categories. In the illustrated embodiment, this includes a first class “A,” a second class “B,” and a third class “N.” Of course, in embodiments, there may be any number of classes/categories.

As illustrated, the output of the Main Classifier 105 undergoes Credibility Assessments 110A-N. In embodiments, this may occur during the training phase, during runtime, or both. In one embodiment, the Credibility Assessments 110 include determining a quality of the Main Classifier 105 with respect to each class (e.g., classes A through N). In embodiments, the quality may refer to the performance, accuracy, precision, recall, or any other metric used to evaluate ML models. In the illustrated embodiment, the Credibility Assessment 110A is used to determine whether the performance of the Main Classifier 105 with respect to the class “A” meets the predefined minimum criteria. Similarly, the Credibility Assessment 110B evaluates the performance with respect to class “B,” and the Credibility Assessment 110N evaluates the Main Classifier 105 performance with respect to class “N.”

In some embodiments, the Credibility Assessments 110A-N determine whether the model performance is sufficient for a given class based on class-specific requirements. In other embodiments, some criteria may be shared across classes. As illustrated, the Credibility Assessment 110N has concluded that the Main Classifier 105 is sufficiently accurate with respect to class “N.” In such an embodiment, if Main Classifier 105 returns class “N” as output for the Input 102, this output is used as the Output Classification 120B for the ML models. As further illustrated, with respect to the classes “A” and “B,” the Credibility Assessments 110A and 110B have determined that the Main Classifier 105 does not meet the predefined performance criteria. Thus, the system has generated and trained a Secondary Classifier 115 for these classes.

In some embodiments, the system utilizes one or more different values in training the Secondary Classifier 115 to attempt to achieve better results for the identified classes. For example, the Secondary Classifier 115 may be trained with different class weights, using a different loss function, different hyperparameters, and the like. In one embodiment, the system uses the training data that was used to train the Main Classifier 105 in order to train the Secondary Classifier 115. In another embodiment, the system identifies a subset of the original training data to be used to train the Secondary Classifier 115. In one such embodiment, the system identifies training data that corresponds to the poor-performing classes, and uses this subset of exemplars to train the Secondary Classifier 115. In the illustrated embodiment, this would involve identifying the training exemplars labeled as class “A” and class “B,” and training the Secondary Classifier 115 using only these exemplars (e.g., excluding exemplars labeled “N” or other classes).

In the illustrated embodiment, during runtime, if the Main Classifier 105 classifies the Input 102 as class “A” or “B,” the system provides the Input 102 to the Secondary Classifier 115 in order to generate the final Output Classification 120A. In this way, the system can improve the performance of the overall architecture with respect to classes A and B, without affecting the (already sufficient) performance of the architecture with respect to class N. That is, because the Secondary Classifier 115 is used to further refine the classification for some classes, the Main Classifier 105 is not retrained or refined, and its performance with respect to class N and other classes is unchanged.

In some embodiments, in addition to (or instead of) performing Credibility Assessments 110 during training, the system applies a similar assessment during active use of the architecture. For example, in one embodiment, in addition to an output classification, each model further provides a confidence in this prediction. In some embodiments, the Credibility Assessments 110A-N evaluate this confidence for a given Input 102 in order to determine whether to return the classification, or to provide the Input 102 to a Secondary Classifier 115. For example, in such an embodiment, if the Main Classifier 105 classifies the Input 102 as class “A” with a given confidence, the Credibility Assessment 110A can compare the confidence to predefined thresholds. If the confidence exceeds the required threshold, the classification can be returned immediately. In contrast, if the classification is below the threshold(s), the Input 102 is provided to the Secondary Classifier 115 in order to generate final output.

FIG. 1B depicts a self-structured hierarchical machine learning classifier, according to one embodiment disclosed herein. In the illustrated workflow 100B, the system is configured to group classes into different groups (each with a respective classifier) based on the required performance levels of the classes. In an embodiment, an initial Group Classifier 155 can be trained to identify the group to which the Input 150 belongs. The Input 150 can then be routed to the appropriate Main Classifier 160A-B. In an embodiment, if the group includes only a single class no Main Classifier 160 is required and the output of the Group Classifier 155 is used as the output of the overall architecture.

In the illustrated embodiment, two or more classes (e.g., classes “A and “B”) are identified as requiring 95% or better accuracy, while two or more other classes (e.g., classes “C” and “D”) require 75% accuracy. In an embodiment, the required accuracy for a given class is defined by one or more users. As illustrated, the system has trained a Group Classifier 155 to classify the Input 150 into the appropriate group, such that the Input 150 can be routed to the appropriate classifier. To do so, in one embodiment, the system identifies training exemplars corresponding to each group and labels them appropriately (e.g., labeling exemplars corresponding to classes “A” and “B” with a first group label, and labeling exemplars corresponding to classes “C” and “D” with a second group label). The Group Classifier 155 can then be trained on this group-labelled data. Similarly, the Main Classifiers 160A-B can be trained using the exemplars belonging to the corresponding classes, as discussed above. That is, continuing the above example, the Main Classifier 160A is trained based on data corresponding to classes “A” and “B,” while the Main Classifier 160B is trained based on data corresponding to classes “C” and “D.”

In an embodiment, this enables the Main Classifiers 160A-B to be trained, tuned, and refined separately until the desired accuracy is achieved. For example, once the Main Classifier 160B reaches 75% accuracy, training can cease and it can be used to generate Output Classifications 165B for the relevant classes. Further, if the Main Classifier 160A has not yet reached sufficient accuracy of 95%, training can continue (e.g., by requesting additional exemplars, modifying hyperparameters, and the like) until the predefined accuracy is achieved. Advantageously, the performance of the Main Classifier 160B is unchanged during this process.

Further, in both workflows 100A and 100B, the secondary classifiers can be trained more efficiently than the initial classifiers. For example, because the Secondary Classifier 115 can be trained on less data than the Main Classifier 105 (e.g., using fewer exemplars and/or exemplars corresponding to fewer classes), the Secondary Classifier 115 can be trained more rapidly, as compared to retraining or refining the Main Classifier 105. Similarly, because the Main Classifiers 160A and 160B are trained separately on reduced data sets, they can each be refined, retrained, and/or replaced more rapidly, as compared to training a single classifier to evaluate all of the classes. Thus, embodiments of the present disclosure reduce computational resources required to train and refine the models, and further reduce the time required to generate the hierarchical architecture.

Of course, the workflows 100A and 100B may be combined in order to further improve the performance of the ML system. For example, suppose the Main Classifier 160A has acceptable performance for one or more of the corresponding classes, but not for one or more other classes. In an embodiment, the system may automatically generate and train additional classifiers to follow the Main Classifier 160A, as discussed in reference to the workflow 100A. In this way, the system can ensure satisfactory classes are not harmed by efforts to improve unsatisfactory classes.

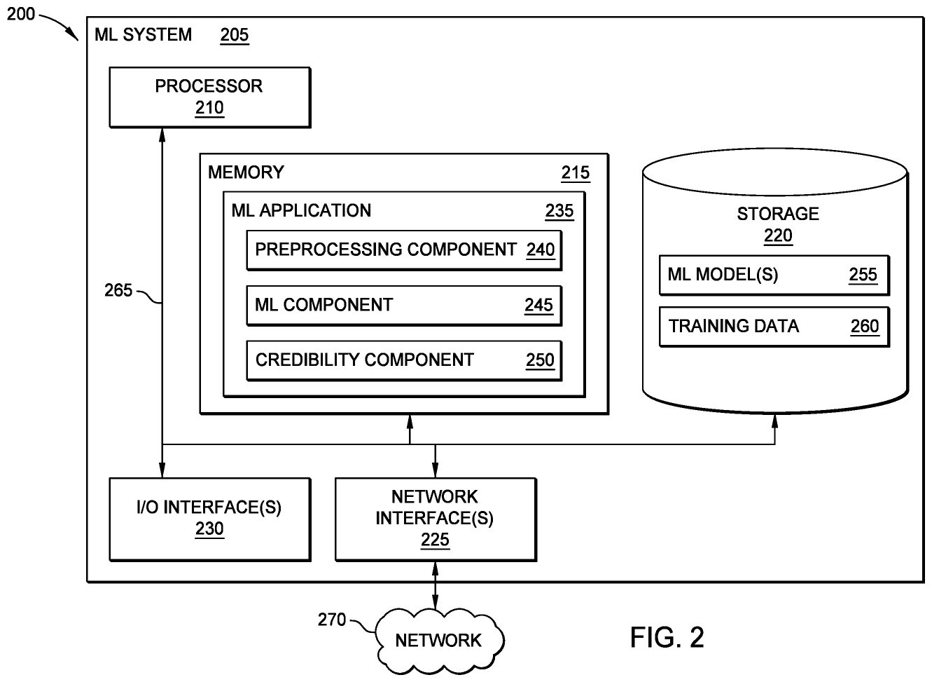

FIG. 2 is a block diagram illustrating a ML System 205 configured to structure and train hierarchical machine learning models, according to one embodiment disclosed herein. Although depicted as a physical device, in embodiments, the ML System 205 may be implemented using virtual device(s), and/or across a number of devices (e.g., in a cloud environment). As illustrated, the ML System 205 a Processor 210, Memory 215, Storage 220, a Network Interface 225, and one or more I/O Interfaces 230. In the illustrated embodiment, the Processor 210 retrieves and executes programming instructions stored in Memory 215, as well as stores and retrieves application data residing in Storage 220. The Processor 210 is generally representative of a single CPU and/or GPU, multiple CPUs and/or GPUs, a single CPU and/or GPU having multiple processing cores, and the like. The Memory 215 is generally included to be representative of a random access memory. Storage 220 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, input and output devices (such as keyboards, monitors, etc.) are connected via the I/O Interface(s) 230. Similarly, via the Network Interface 225, the ML System 205 can be communicatively coupled with one or more other devices and components (e.g., via the Network 270, which may include the Internet, local network(s), and the like). As illustrated, the Processor 210, Memory 215, Storage 220, Network Interface(s) 225, and I/O Interface(s) 230 are communicatively coupled by one or more Buses 265.

In the illustrated embodiment, the Storage 220 includes one or more ML Models 255, as well as labeled Training Data 260. In some embodiments, the ML Models 255 are trained classifiers. In one embodiment, each ML Model 255 is a convolutional neural network (CNN) or a deep CNN (DCNN). In an embodiment, the Training Data 260 includes labeled exemplars used to train the ML Models 255. For example, if the ML System 205 is configured to evaluate/categorize images, the Training Data 260 can include digital images, each with one or more corresponding labels used to train the ML Models 255.

As illustrated, the Memory 215 includes a ML Application 235. Although depicted as software residing in Memory 215, in embodiments, the ML Application 235 may be implemented using hardware, software, or a combination of hardware and software. The ML Application 235 generally generates, trains, and structures the ML Models 255 using Training Data 260 in order to create hierarchical architectures capable of evaluating and classifying input data. In some embodiments, the ML Application 235 can automatically identify underperforming class(es) and implement solutions (such as training secondary classifiers) in a way that preserves the performance of already-trained classes and/or models. Further, in one embodiment, the ML Application 235 can similarly add or refine classes while minimizing or eliminating the potential effects from existing classes and/or models.

In the illustrated embodiment, the ML Application 235 includes a Preprocessing Component 240, an ML Component 245, and a Credibility Component 250. Although depicted as discrete components for conceptual clarity, in embodiments, the operations of the Preprocessing Component 240, ML Component 245, and Credibility Component 250 can be combined or distributed across any number of components.

In an embodiment, the Preprocessing Component 240 performs any preprocessing on input data and/or Training Data 260 prior to evaluating it with the ML Models 255. For example, the Preprocessing Component 240 may normalize the data, convert it to another format if needed, and the like. In some embodiments, the Preprocessing Component 240 also partitions the Training Data 260 prior to use in training the ML Models 255. For example, in one embodiment, the Preprocessing Component 240 partitions the Training Data 260 into a training set and one or more test sets. In embodiments, the training set is used to train one or more ML Models 255, while the test set(s) are used to evaluate the performance of the models. In some embodiments, separate test sets are defined for each layer of the hierarchical classifiers. For example, a first test set can be defined to evaluate the initial main classifier, while a second test set is used to evaluate the secondary classifier(s). Of course, additional test sets may be used for additional layers (e.g., for tertiary classifiers, and so on).

In some embodiments, the Preprocessing Component 240 additionally identifies the relevant data for training a given ML Model 255. For example, the Preprocessing Component 240 may select all of the available Training Data 260 (or the corresponding training subset of the Training Data 260) for training the initial main classifier. For secondary or subsequent classifier(s) being trained for particular class(es), the Preprocessing Component 240 may identify the appropriate subset of Training Data 260 for training the models.

In an embodiment, the ML Component 245 receives the identified and/or partitioned Training Data 260 and trains one or more ML Models 255. In some embodiments, the ML Component 245 initially trains a main classifier ML Model 255, and awaits further instruction (e.g., from the Credibility Component 250 and/or from a user) prior to training additional models. In one embodiment, if the Credibility Component 250 identifies one or more classes for which the ML Model 255 is insufficient, the ML Component 245 requests corresponding training data (e.g., from the Preprocessing Component 240) and trains one or more additional ML Models 255 for the identified classes. This process may be repeated until sufficient accuracy is achieved (or until no additional data is available).

In embodiments, the Credibility Component 250 evaluates the quality or performance of the ML Models 255 in order to instruct the ML Component 245 how to proceed. For example, in one embodiment, the Credibility Component 250 generates a confusion matrix by evaluating one or more test sets of data using the initial ML Model 255, in order to identify class(es) that demonstrate sufficient performance and/or inadequate performance. In an embodiment, this includes determining, for each respective class, a percentage of the test exemplars that are correctly classified into the class (e.g., a true positive), incorrectly classified into other classes (e.g., a false negative), incorrectly classified into the class (e.g., a false positive) and/or correctly classified into other classes (e.g., a true negative). In embodiments, the Credibility Component 250 can similarly evaluate any other quality metrics for the ML Models 255, such as precision, recall, and the like.

In an embodiment, the Credibility Component 250 compares each determined class-specific quality to predefined threshold(s) or criteria (e.g., provided by a user) in order to identify underperforming classes (e.g., classes which the ML Model 255 has not adequately learned). The Credibility Component 250 can then return an indication of these classes, such that the ML Component 245 can train one or more additional ML Models 255 to better-evaluate input data. In an embodiment, once these classifiers are trained, the Credibility Component 250 similarly evaluates each in order to determine whether additional training and/or models are required.

In some embodiments, the Credibility Component 250 can similarly evaluate the credibility of individual outputs during runtime. For example, in one such embodiment, when the ML Component 245 generates an output classification for a given input, the Credibility Component 250 can compare the corresponding confidence to one or more thresholds in order to determine whether to return the output to the requesting entity, or to process the received input using one or more additional ML Models 255.

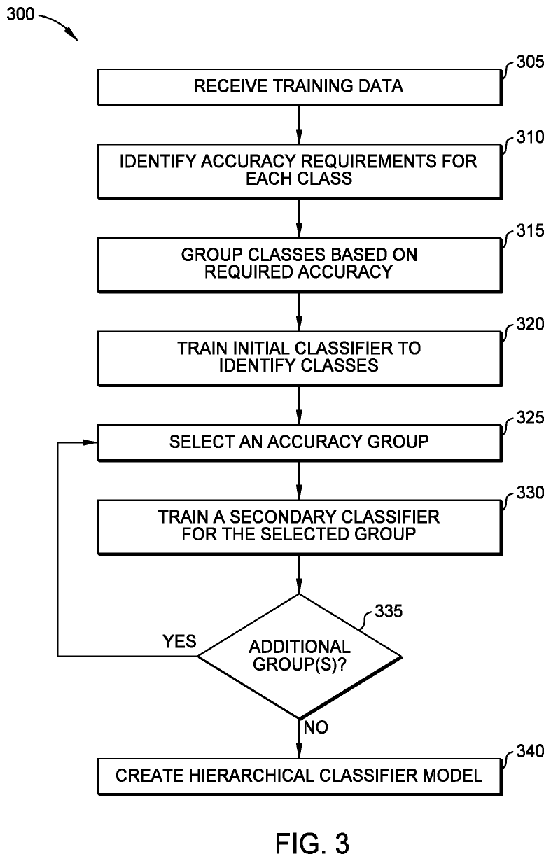

FIG. 3 is a flow diagram illustrating a method 300 of training hierarchical machine learning models, according to one embodiment disclosed herein. The method 300 begins at block 305, where the ML Application 235 receives training data, where the training data includes labels for the various classes to be identified. At block 310, the ML Application 235 identifies any defined accuracy/precision/performance requirements for each class in the labeled training data. The method 300 then continues to block 315, where the ML Application 235 groups the identified classes based on their corresponding required performance. For example, the ML Application 235 can group all classes requiring 75% accuracy into a first group, all classes requiring 80% accuracy into a second group, and so on.

At block 320, the ML Application 235 trains an initial group classifier to identify accuracy groups and/or classes. In one embodiment, the ML Application 235 labels training data within a given accuracy group with a common label, and trains the initial classifier to categorize input into the appropriate accuracy group. In another embodiment, the ML Application 235 trains the initial classifier to categorize input into the appropriate class, and uses this predicted class to identify the appropriate second classifier (e.g., to identify the classifier corresponding to the accuracy group to which the predicted class belongs). The method 300 then continues to block 325, where the ML Application 235 selects one of the generated accuracy groups.

At block 330, if the selected accuracy group includes more than one class, the ML Application 235 trains a secondary classifier to categorize input into a class from the accuracy group. To do so, in one embodiment, the ML Application 235 uses only training data labeled with one or more of the classes included in the accuracy group (e.g., ignoring training data that corresponds to any classes not included within the group). In one embodiment, if the selected accuracy group contains a single class, the ML Application 235 does not train a secondary classifier, but instead uses the output from the initial classifier as the final output.

The method 300 then proceeds to block 335, where the ML Application 235 determines whether there is at least one additional accuracy group to be evaluated. If so, the method 300 returns to block 325 to select an accuracy group that has not yet been processed. If all of the accuracy groups have been evaluated, the method 300 proceeds to block 340. At block 340, the ML Application 235 creates a hierarchical classifier model architecture by linking the secondary classifier(s), if any, to the initial classifier as appropriate. For example, as illustrated in FIG. 1B, the ML Application 235 can establish an architecture whereby the input data is processed by an initial classifier (e.g., Group Classifier 155) in order to identify the appropriate secondary classifier (e.g., a Main Classifier 160A-B). This secondary classifier can then evaluate the input in order to generate a final output classification.

Advantageously, establishing separate accuracy groups enables the distinct secondary classifiers to be trained, refined, and tuned independently. This allows the ML Application 235 to preserve the performance of a given classifier/class once it is established, while enabling the ML Application 235 to continue to improve performance for other classes.

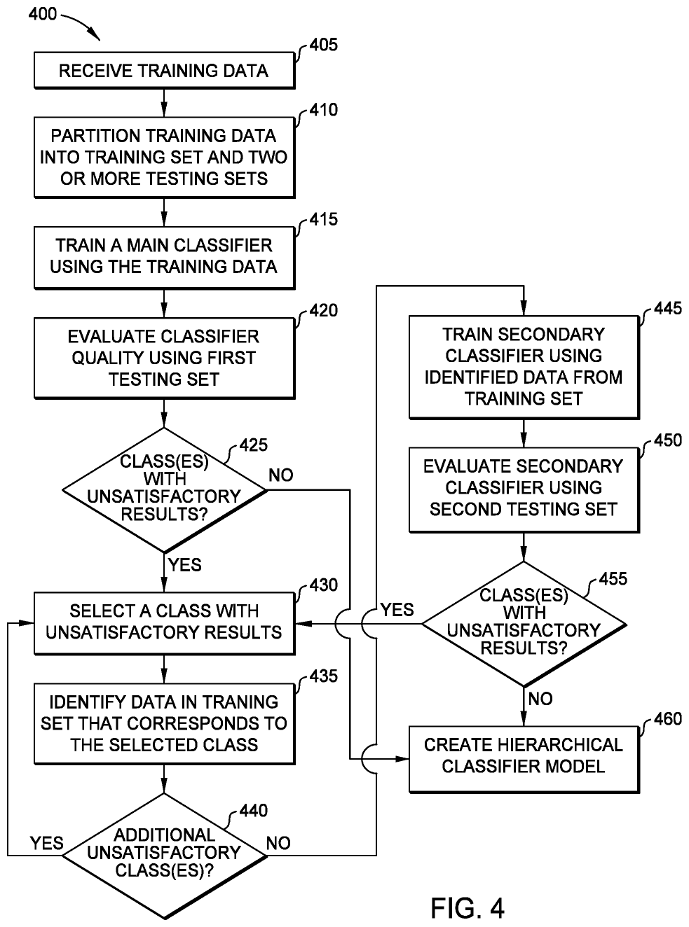

FIG. 4 is a flow diagram illustrating a method 400 of training hierarchical machine learning models, according to one embodiment disclosed herein. The method 400 begins at block 405, where the ML Application 235 receives training data. At block 410, the ML Application 235 partitions the training data into at least a training set and two testing sets. The method 400 then proceeds to block 415, where the ML Application 235 trains an initial main classifier using the training data set, as discussed above. That is, the ML Application 235 trains a main classifier to categorize input data into the appropriate class, based on the training set.

At block 420, the ML Application 235 evaluates the quality/performance of the main classifier using the first testing data set in order to determine a class-specific performance for each class. As discussed above, this can include, for example, generating a confusion matrix, determining the precision of each class, and the like. At block 425, the ML Application 235 determines, based on this evaluation and the predefined performance requirements, whether there are any classes that are not predicted with sufficient accuracy. If not (e.g., if all of the classes are sufficiently accurate), the method 400 proceeds to block 460, where the ML Application 235 finalizes the classifier model and readies it for deployment. If there is at least one class with unsatisfactory results, however, the method 400 proceeds to block 430.

At block 430, the ML Application 235 selects one of the identified class(es) that has poor results. At block 435, the ML Application 235 identifies the data from the training set that corresponds to the selected class. For example, if the class “flower” performed poorly, the ML Application 235 identifies each exemplar in the training set that is labeled “flower.” This subset of the training set is to be used to train supplementary classifier(s). At block 440, the ML Application 235 determines whether there is at least one additional unsatisfactory class for which training data has not been identified and retrieved. If so, the method 400 returns to block 430. Otherwise, the method 400 continues to block 445. At block 445, the ML Application 235 uses the identified subset of the training data set (e.g., the exemplars identified at block 435) to train a secondary classifier. In some embodiments, the method 400 then proceeds to block 460 to finalize the model architecture.

In the illustrated embodiment, however, the method 400 proceeds to block 450, where the ML Application 235 similarly evaluates the secondary classifier. In an embodiment, the ML Application 235 does so using the second testing set. This evaluation can include, for example, generating a confusion matrix, evaluating class-specific precision, and the like. At block 455, the ML Application 235 similarly determines whether the secondary classifier has unsatisfactory performance with respect to any of the classes. If so, in one embodiment, the method 400 returns to block 430. This process can be iterated until all classes are adequately predicted. In another embodiment, the ML Application 235 requests additional data and retrains the secondary classifier until performance is adequate.

If the ML Application 235 determines that the class performance is sufficient for all classes, the method 400 proceeds to block 460, where the ML Application 235 creates and finalizes the hierarchical classifier architecture. For example, as illustrated in FIG. 1A, the ML Application 235 can establish an architecture whereby the input data is processed by an initial classifier (e.g., Main Classifier 105) in order to determine whether to directly output the results, or to evaluate the input data with a secondary classifier (e.g., Secondary Classifier 115).

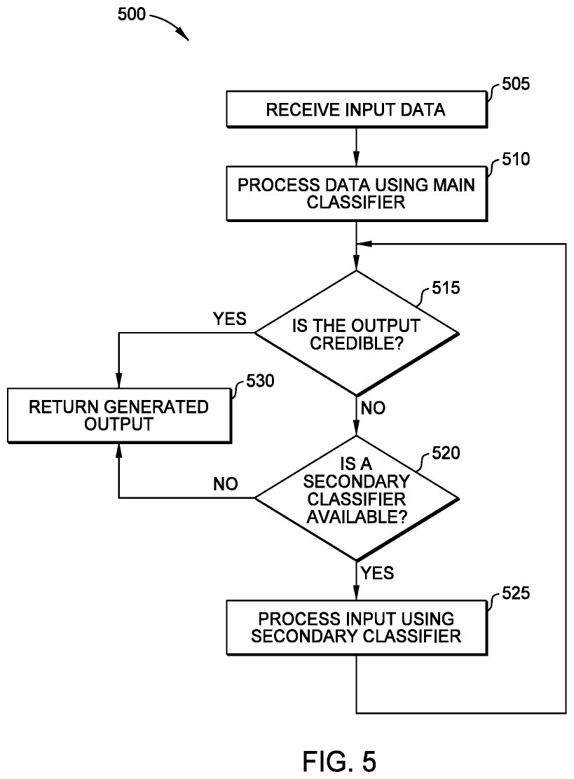

FIG. 5 is a flow diagram illustrating a method 500 of processing data using hierarchical machine learning models, according to one embodiment disclosed herein. The method 500 begins at block 505, where the ML Application 235 receives input data. At block 510, the ML Application 235 processes this input data using an initial classifier (e.g., Main Classifier 105). The method 500 then proceeds to block 515, where the ML Application 235 determines whether the corresponding output classification is credible. In one embodiment, the ML Application 235 does so by determining whether the predicted class is associated with one or more secondary classifiers. That is, the ML Application 235 can determine whether the indicated class was identified as inadequate or unsatisfactory during training. In another embodiment, the ML Application 235 evaluates the credibility of the output based on the confidence score generated by the main classifier.

If, at block 515, the ML Application 235 determines that the output is credible, the method 500 proceeds to block 530, where the ML Application 235 returns the generated classification as the final output of the architecture (e.g., as Output Classification 120B). In contrast, if the ML Application 235 determines that the output is not credible (e.g., because it belongs to a suspect class and/or because the confidence was below a defined threshold), the method 500 continues to block 520. At block 520, the ML Application 235 determines whether the hierarchical architecture includes a secondary classifier that has been trained to recognize the class predicted by the main classifier. If not, the method 500 proceeds to block 530 where the generated output is returned.

If a secondary classifier is available, the method 500 continues to block 525 where the ML Application 235 processes the received input using this secondary classifier (e.g., Secondary Classifier 115). The method 500 then returns to block 515 to perform a credibility assessment, as discussed above. In some embodiments, this process repeats until a credible classification is returned, or no additional classifiers remain. In another embodiment, the ML Application 235 can simply return the output of the secondary classifier.

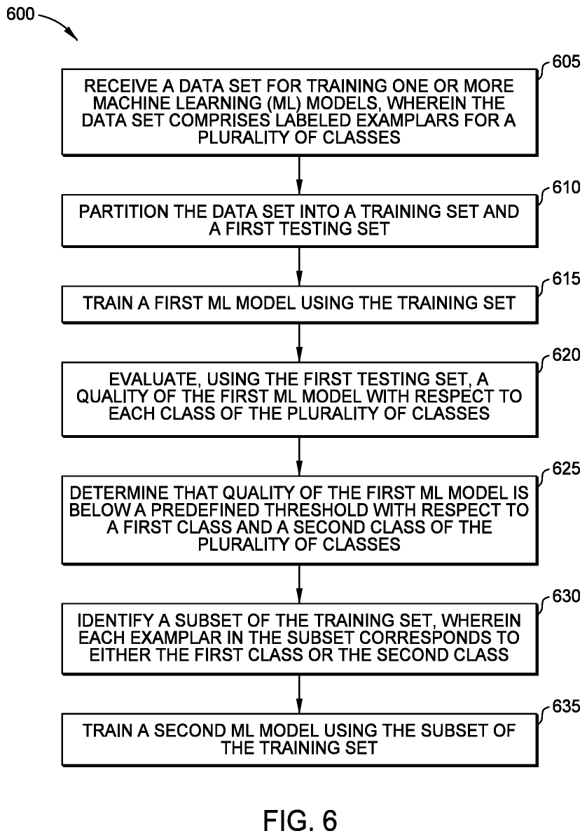

FIG. 6 is a flow diagram illustrating a method 600 of using hierarchical machine learning models, according to one embodiment disclosed herein. The method 600 begins at block 605, where a ML Application 235 receives a data set for training one or more machine learning (ML) models, wherein the data set comprises labeled exemplars for a plurality of classes. At block 610, the ML Application 235 partitions the data set into a training set and a first testing set. The method 600 then continues to block 615, where the ML Application 235 trains a first ML model using the training set. Further, at block 620, the ML Application 235 evaluates, using the first testing set, a quality of the first ML model with respect to each class of the plurality of classes. The method 600 proceeds to block 625, where the ML Application 235 determines that quality of the first ML model is below a predefined threshold with respect to a first class and a second class of the plurality of classes. Based on this determination, at block 630, the ML Application 235 identifies a subset of the training set, wherein each exemplar in the subset corresponds to either the first class or the second class. Additionally, at block 635, the ML Application 235 trains a second ML model using the subset of the training set.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding and following, reference is made to embodiments presented in this disclosure. However, the scope of the present disclosure is not limited to specific described embodiments. Instead, any combination of the preceding and following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding and following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications (e.g., the ML Application 235) or related data available in the cloud. For example, the ML Application 235 could execute on a computing system in the cloud and train and configure machine learning models. In such a case, the ML Application 235 could evaluate models and create hierarchical architectures, and store the trained models at a storage location in the cloud. Doing so allows a user to access this information from any computing system attached to a network connected to the cloud (e.g., the Internet).

While the foregoing is directed to embodiments of the present invention, other and further embodiments of the invention may be devised without departing from the basic scope thereof, and the scope thereof is determined by the claims that follow.

What is claimed is:

1. A method comprising:
receiving a data set for training one or more machine learning (ML) models, wherein the data set comprises labeled exemplars for a plurality of classes;
partitioning the data set into a training set and a first testing set;
training a first ML model using the training set;
evaluating, using the first testing set, a quality of the first ML model with respect to each class of the plurality of classes; and
upon determining that quality of the first ML model is below a predefined threshold with respect to a first class and a second class of the plurality of classes:
identifying a subset of the training set, wherein each exemplar in the subset corresponds to either the first class or the second class; and
training a second ML model using the subset of the training set.

2. The method of claim 1, wherein partitioning the data set further comprises partitioning the data set into a second testing set, the method further comprising:
evaluating a quality of the second ML model with respect to the first and second classes; and
upon determining that the second ML model is satisfactory with respect to the first and second classes:
creating a hierarchical ML model comprising the first and second ML models.

3. The method of claim 2, wherein creating the hierarchical ML model comprises linking an input of the second ML model to output of the first ML model, such that when the first ML model classifies input data as belonging to the first or second class, the input data is forwarded to the second ML model for final classification.

4. The method of claim 1, wherein evaluating the quality of the first ML model comprises:
generating a confusion matrix by processing the first testing set using the first ML model; and
determining a precision of the first ML model with respect to each class of the plurality of classes, based on the confusion matrix.

5. The method of claim 1, the method further comprising:
grouping the plurality of classes based on a required accuracy for each class of the plurality of classes;
training a classifier ML model for each group of classes; and
training a group ML model to assign input to one of the classifier ML models.

6. The method of claim 1, the method further comprising:
receiving a first input;
processing the first input using the first ML model; and
upon determining, based on output of the first ML model, that the first input corresponds to either the first class or the second class:
processing the first input using the second ML model; and
returning output of the second ML model.

7. The method of claim 6, the method further comprising:
receiving a second input;
processing the second input using the first ML model; and
upon determining, based on output of the first ML model, that the second input corresponds to a third class of the plurality of classes, returning the output of the first ML model.

8. A computer-readable storage medium containing computer program code that, when executed by operation of one or more computer processors, performs an operation comprising:
receiving a data set for training one or more machine learning (ML) models, wherein the data set comprises labeled exemplars for a plurality of classes;
partitioning the data set into a training set and a first testing set;
training a first ML model using the training set;
evaluating, using the first testing set, a quality of the first ML model with respect to each class of the plurality of classes; and
upon determining that quality of the first ML model is below a predefined threshold with respect to a first class and a second class of the plurality of classes:
identifying a subset of the training set, wherein each exemplar in the subset corresponds to either the first class or the second class; and
training a second ML model using the subset of the training set.

9. The computer-readable storage medium of claim 8, wherein partitioning the data set further comprises partitioning the data set into a second testing set, the operation further comprising:
evaluating a quality of the second ML model with respect to the first and second classes; and
upon determining that the second ML model is satisfactory with respect to the first and second classes:
creating a hierarchical ML model comprising the first and second ML models.

10. The computer-readable storage medium of claim 9, wherein creating the hierarchical ML model comprises linking an input of the second ML model to output of the first ML model, such that when the first ML model classifies input data as belonging to the first or second class, the input data is forwarded to the second ML model for final classification.

11. The computer-readable storage medium of claim 8, wherein evaluating the quality of the first ML model comprises:
generating a confusion matrix by processing the first testing set using the first ML model; and
determining a precision of the first ML model with respect to each class of the plurality of classes, based on the confusion matrix.

12. The computer-readable storage medium of claim 8, the operation further comprising:
grouping the plurality of classes based on a required accuracy for each class of the plurality of classes;
training a classifier ML model for each group of classes; and
training a group ML model to assign input to one of the classifier ML models.

13. The computer-readable storage medium of claim 8, the operation further comprising:
receiving a first input;
processing the first input using the first ML model; and
upon determining, based on output of the first ML model, that the first input corresponds to either the first class or the second class:
processing the first input using the second ML model; and
returning output of the second ML model.

14. The computer-readable storage medium of claim 13, the operation further comprising:
receiving a second input;
processing the second input using the first ML model; and
upon determining, based on output of the first ML model, that the second input corresponds to a third class of the plurality of classes, returning the output of the first ML model.

15. A system comprising:
one or more computer processors; and
a memory containing a program which when executed by the one or more computer processors performs an operation, the operation comprising:
receiving a data set for training one or more machine learning (ML) models, wherein the data set comprises labeled exemplars for a plurality of classes;
partitioning the data set into a training set and a first testing set;
training a first ML model using the training set;
evaluating, using the first testing set, a quality of the first ML model with respect to each class of the plurality of classes; and
upon determining that quality of the first ML model is below a predefined threshold with respect to a first class and a second class of the plurality of classes:
identifying a subset of the training set, wherein each exemplar in the subset corresponds to either the first class or the second class; and
training a second ML model using the subset of the training set.

16. The system of claim 15, wherein partitioning the data set further comprises partitioning the data set into a second testing set, the operation further comprising:
evaluating a quality of the second ML model with respect to the first and second classes; and
upon determining that the second ML model is satisfactory with respect to the first and second classes:
creating a hierarchical ML model comprising the first and second ML models comprising linking an input of the second ML model to output of the first ML model, such that when the first ML model classifies input data as belonging to the first or second class, the input data is forwarded to the second ML model for final classification.

17. The system of claim 15, wherein evaluating the quality of the first ML model comprises:
generating a confusion matrix by processing the first testing set using the first ML model; and
determining a precision of the first ML model with respect to each class of the plurality of classes, based on the confusion matrix.

18. The system of claim 15, the operation further comprising:
grouping the plurality of classes based on a required accuracy for each class of the plurality of classes;
training a classifier ML model for each group of classes; and
training a group ML model to assign input to one of the classifier ML models.

19. The system of claim 15, the operation further comprising:
receiving a first input;
processing the first input using the first ML model; and
upon determining, based on output of the first ML model, that the first input corresponds to either the first class or the second class:
processing the first input using the second ML model; and
returning output of the second ML model.

20. The system of claim 19, the operation further comprising:
receiving a second input;
processing the second input using the first ML model; and
upon determining, based on output of the first ML model, that the second input corresponds to a third class of the plurality of classes, returning the output of the first ML model.
